(19) United States
(12) Patent Application Publication
(10) Pub. No.: US 2016/0098684 A1
(43) Pub. Date: Apr. 7, 2016

(54) Dual Education Student Apprentice Program

(71) Applicants: Colby Dean Callaway, North Bend, OR (US); Tracy Rene Kidd-Callaway, North Bend, OR (US)

(72) Inventors: Colby Dean Callaway, North Bend, OR (US); Tracy Rene Kidd-Callaway, North Bend, OR (US)

(21) Appl. No.: 14/507,583

(22) Filed: Oct. 6, 2014

(51) Int. Cl. G06Q 10/10

(52) U.S. Cl. CPC G06Q 10/1053; G06Q 50/20

(57) ABSTRACT

A dual education student apprentice program that provides students with job skills and the necessary incentive to enter the work force by training the students in the occupational field of their choice while concurrently providing the students with a standard educational program is provided herein. The student apprentice program provides students with the opportunity to receive on-the-job training in the field of their choice while attending a standard educational program such as high school or a similar curriculum. Apprentices completing the program are immediately ready to accept jobs and enter into the local workforce. The student apprentice program benefits local communities by providing competent and qualified employees for local businesses.

### FIELD OF THE INVENTION

The present relates, generally, to increasing the efficiency of recruiting and identifying the suitable employees for a business. More particularly, embodiments of the present invention are directed to training high school students through a merit-based apprentice program so that they are able to enter a local workforce as competent, capable employees.

### BACKGROUND OF THE INVENTION

When an organization has a need to fill an employment position, whether full time or part time, conventional means of recruiting are somewhat slow and burdensome. In one conventional means, an organization with an open position advertises the position in a newspaper and/or trade journal. Often, the position is only temporary, such as the need for a nurse to work only a few open shifts or a few hours. Additionally, in a large organization with constant turnover of employees or constant needs to fill open permanent and temporary positions, advertising the positions can be inefficient and only moderately effective. A representative of the organization must use considerable time to post and repost advertisements, as well as reply to those candidates who show interest in the open positions. Further, the method of using both internally and externally published advertisements does not reach a large enough portion of the intended pool of candidates. In some situations, a recruiting agency, or “registry,” may be employed to assist in recruiting candidates and advertising available positions.

When an interested candidate is located, the recruiting agencies/registries encourage the candidates to apply for the position. However, the candidate's qualifications must be reviewed and matched by the recruiting agency and the hiring organization before a decision is made to interview and ultimately hire the candidate.

After interviewing a number of candidates, the organization decides which candidate is most qualified for the position, based on experience and salary. Ideally, the organization would like to hire the most experienced candidate at the lowest possible salary. Upon reviewing resumes and conducting interviews, the organization becomes aware of the most qualified candidates. The organization must also address salary or payment for the position.

Apprentice programs are known within the art. Within a workforce, certain skills lend themselves to certain job titles. In order for the transfer of skills between individuals, apprentice programs can be instituted. These programs see workers unskilled in a specific art applying and learning a trade under the direct supervision and counsel of experienced individuals who are already practicing the art. This can be beneficial for the learner, as practicing an art hand-on can be much more educationally and economically beneficial than conventional means of classroom-style learning. The individual overseeing the learning may also benefit from the experience, as teaching an art can solidify knowledge and potentially provide fresh insights into a practiced routine.

Unfortunately, no such dual education apprentice programs exist for high school students. It is known that high school students with no intention of higher education i.e.: college or trade schools, do not apply the same efforts into their classroom time as a student attempting to absorb college-bound topics. This can create an unequal environment within the classroom, as studious individuals will need to learn potentially critical studies at the rate of those individuals which have no interest in the subject being taught. If no higher education is intended, these students generally enter the workforce with little to no training in any specific field, making it difficult for them to find employment.

It could be said there lies a need for a dual education job-recruitment method which places high school students into a credited apprentice program in order to gain valuable skills.

The present invention meets this need by providing a dual education method for placing high school students into paid apprentice programs while the students complete a standard educational program.

### BRIEF SUMMARY OF THE INVENTION

The present invention is a dual education student apprentice program that provides students with job skills and the necessary incentive to enter the work force by training the students in the occupational field of their choice while concurrently providing the students with a standard educational program. Students enter into the apprentice program where they receive on-the-job training while attending a standard educational program, such as high school, or a similar curriculum. The student apprentice program is intended to benefit local communities by providing the businesses in a community with qualified, competent, and capable employees.

In one embodiment of the present invention, a student enters into a student apprentice program that is overseen by an administrative body. Upon entry into the program, the student is considered to be an apprentice and is offered a variety of employment options from businesses participating in the program. The employment options represent various fields or professions in which the apprentice can become employed. The apprentice selects a field of employment and begins on-the-job training with the business that is offering the employment option. The apprentice must perform his or duties satisfactorily and must concurrently complete a standard educational program at an educational facility such as a high school.

The administration operates the apprentice program in a similar fashion to a traditional temporary staffing agency. The administration is responsible for soliciting businesses to become part of the program and provide employment opportunities to the apprentices. The businesses solicited by the administration will be businesses local to the community in which the program is established. The goal of the program is to support and foster local business growth by providing capable employees for those businesses. The administration is also responsible for operating the business functions of the program including, but not limited to, payroll, hiring and placement of the apprentices, accounting, charging businesses for the apprentices' services and paying the apprentices their wages.

It should be noted that the apprentice program is initially government or grant funded but will become self-sufficient and potentially profitable over time. The program receives revenue by charging a business a higher apprentice wage, deducting an overhead or operating amount, then pays the apprentices a reduced, or minimum wage. The difference between the payment received from the businesses and the salary paid to each apprentice is compensation received by the administration for performing any necessary business services, including payroll and accounting services.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 is a diagram showing the entities involved in a student apprentice program and their interrelations as according to one embodiment of the present invention;

FIG. 2 is a flowchart of an apprentice's progression through a student apprentice program as according to one embodiment of the present invention; and

FIG. 3 is a flowchart of the responsibilities and relationships between a student apprentice program administration and a business that hires a program apprentice as according to one embodiment of the present invention.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a dual education student apprentice program for providing students with job skills and the necessary incentive to enter the work force by training the students in the occupational field of their choice while concurrently requiring the students to complete a standard educational program. For the purpose of clarity, all like elements mentioned in this description, or illustrated in the accompanying Figures, will have the same designations. The terms “dual education student apprentice program”, “student apprentice program”, “apprentice program”, “program”, “present invention”, and “invention” may be used interchangeably. In addition to the functions, features, components, and abilities of the invention already discussed in this specification, the invention may also have, but not be limited to, the following features contained within the description below.

The present invention solves the shortcomings of the prior art by providing a dual education student apprentice program that offers on-the-job training for students and matches students with local businesses that appeal to a student's occupational interests. The program fosters incentive for students to complete their standard educational program and enter the workforce upon graduation from the program an. The student apprentice program can be viewed as an alternative to the traditional college path for students desiring to receive vocational training and begin working for businesses in the student's community immediately upon the completion of high school. Communities that implement the present invention will benefit from the increased supply of competent, qualified and well-trained apprentices that complete the program. The preferred embodiments described below set forth the present invention in greater detail.

It should be noted that the present invention can be used with a plurality of schools or school districts in a community. A community with more than one high school, or closely joined school districts, can use the present invention to serve students from any of the schools or school districts. Students entering the program will be treated the same regardless of the source school or school district. This will allow communities to provide a competent, well trained workforce to businesses in the community regardless of the school attended by the student.

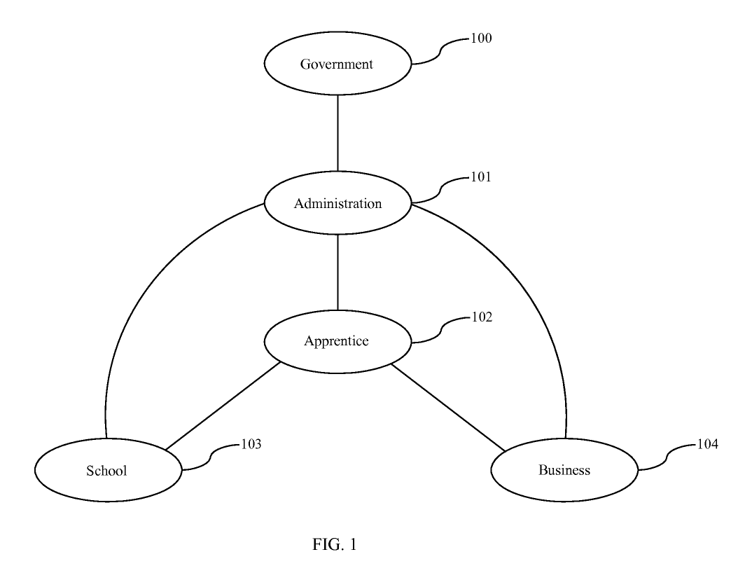

Referring now to FIG. 1, there is a diagram showing the entities involved in a student apprentice program and their interrelations as according to one embodiment of the present invention. The student apprentice program is initially funded by a governmental agency (100) or a government grant. The student apprentice program may begin as a government funded pilot program and have an initial duration of five years. There can be an option to renew government funding at the end of the initial five-year period, but it is expected that the program will be self-sufficient within that timeframe. It is possible, in some embodiments of the present invention, that government funding may not be required at the program's inception. These embodiments comprise student apprentice programs that have been privately funded or are expansions of existing student apprentice programs into a new school (103).

The student apprentice program will be operated and overseen by an administrative body hereinafter referred to as the “administration” (101). The administration (101) operates in a similar fashion to a private business in that it provides accounting services, payroll, recruiting, hiring, and other business services. The administration (101) can be said to operate in a manner similar to that of a traditional temporary staffing agency. The administration (101) deducts an amount from wage payments received from a business (104) as compensation, or income for the administration (101) for providing the business services to the dual education student apprentice program. The administration (101) comprises personnel responsible for the operation of the program including, but not limited to, accountants, recruiting specialists, business liaisons, school liaisons, managers, and anyone else necessary for the proper administration of the program.

The administration (101) works with schools (103) to ensure that each apprentice (102) completes a standard educational program. The standard educational program is a high school curriculum and each apprentice is responsible for attending classes, completing coursework, and passing all of the requisite examinations. The administration (101) is also responsible for bringing businesses (104) into the program and for working with the businesses (104) and apprentices (102) to facilitate the meeting of the goals of all involved parties.

Apprentices (102) within the program are responsible for attending school (103) to complete their standard educational program, performing their occupational duties to meet the expectations of the business (104) that is employing the apprentice (102), and for complying with any requirements set forth by the administration (101). It is expected that upon completion of the student apprentice program and graduation from their standard educational program, the apprentice (102) will continue working for the business (104) that initially hired the apprentice (102).

Businesses (104) involved in the program provide on-the-job training to the apprentice (102) and provide feedback to the administration (101) regarding the progress and performance of the apprentice (102). The businesses (104) involved with the program are local businesses (104) that are already established in a community that is implementing the program. The program benefits local businesses (104) and attempts to benefit the local community by training apprentices (102) and preparing them to take jobs in the local workforce immediately upon graduation from the program. The business (104) can also request replacement of a particular apprentice (102) if he or she is not performing their occupational duties in a satisfactory manner. The student apprentice program is designed to benefit businesses (104) by providing a steady source of qualified workers in a community.

The business (104) pays the administration (101) the apprentice's wages instead of paying the wages directly to the apprentice (102). This allows the administration (101) to deduct a compensation amount which is payment for services rendered to the program. The services rendered by the administration (101) include, but are not limited to, providing accounting services, doing payroll for the business, recruiting students and businesses to become part of the program, and advertising the program within a local community. The compensation deduction is also necessary in that it allows the program to operate self-sufficiently and eliminates the need for additional government funding.

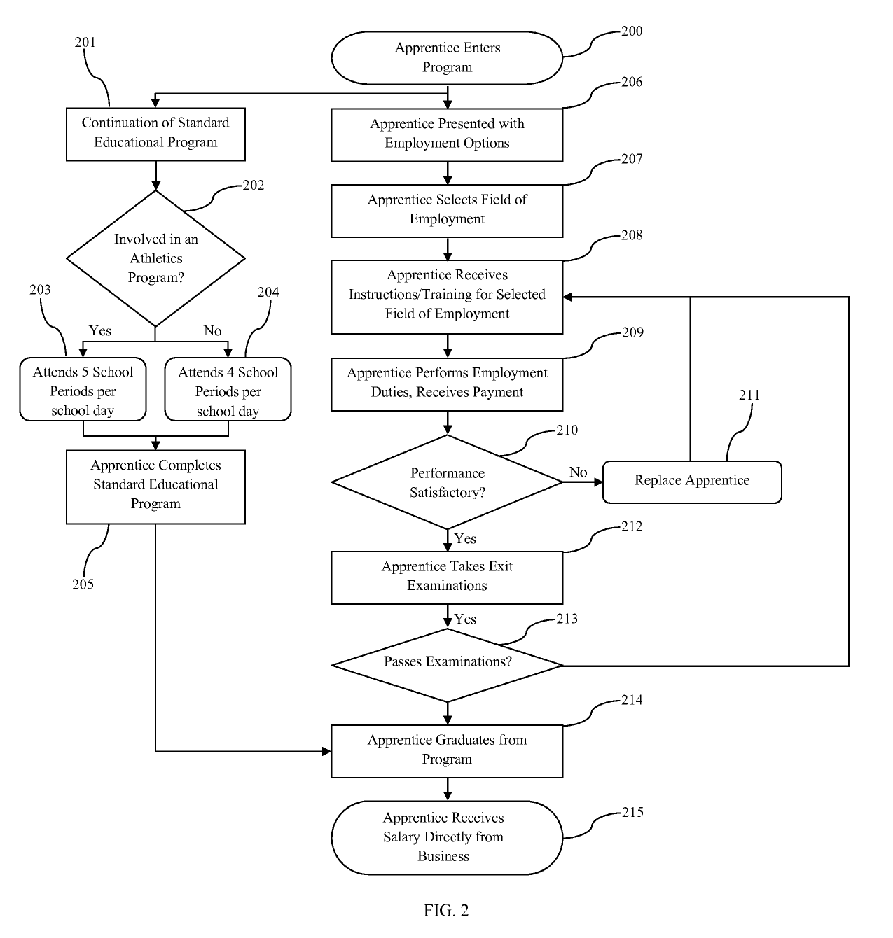

Referring now to FIG. 2, there is shown a flowchart of an apprentice's progression through a student apprentice program as according to one embodiment of the present invention. The student apprentice program is essentially a dual education system where one track requires students to complete their standard high school education, and the other track requires students to complete an apprentice-based learning program. Satisfactory completion of both tracks is required before the apprentice is allowed to graduate from the program.

When a high school student enters the program (200), they are hereinafter referred to as an “apprentice” while participating in the program. Apprentices are responsible for satisfying the requirements of two separate tracks, the continuation of their standard educational program (201), and satisfying the requirements of the business that employs the apprentice.

When continuing their standard educational program (201), an apprentice must decide whether to be involved with a school athletics program (202). The athletics programs an apprentice can become involved with include, but are not limited to, football, basketball, golf, soccer, gymnastics, cycling, volleyball, track and field, baseball, skiing, or any other athletic program offered by a high school. If the apprentice decides to be involved in an athletics program, the apprentice must attend five school periods per school day (203). If the apprentice is not involved in an athletics program, the apprentice must attend four school periods per school day (204). Apprentices must complete their standard educational program (205) before they will be allowed to graduate from the student apprentice program (214).

The student apprentice program is an optional program for high school students. Some students may wish to receive on-the-job training and begin working for businesses sooner instead of pursuing a college education. When a high school student decides to enter into the apprentice program (200), in addition to continuing their standard educational program (201), they are presented with a selection of employment opportunities (206) from which they must choose as their desired occupational field. The employment opportunities can include, but are not limited to, occupations in the following fields: mechanical such as machine or automotive repair, welding, managerial, construction, accounting, restaurant services, automotive sales, automotive body painting, cosmology, retail sales, residential interior or exterior design, clothing design, and the like. The program administration will seek to make available all fields of employment that exist in a student's community. This way, upon graduation from the program (214), apprentices will be able to immediately begin working locally in their community. Community involvement of local businesses and focusing on improving the local community is a goal of the student apprentice program.

After an apprentice selects their field of employment (207), they receive instructions and training for their selected field of employment (208). Instructions and training will be provided to the apprentice (208) by the business that is offering the employment position. Instructions and training can include any sort of vocational education that would be offered to a new employee of the business. The business can provide the apprentice with seminars, training booklets or material, shadowing, training classes, or any other type of on-the-job training that the business deems appropriate before allowing the apprentice to engage in their employment duties.

After completing their instruction and training period, apprentices will perform their employment duties and receive payment for their duties (209). However, it should be noted that apprentices do not receive wages directly from the business while in the apprentice program, but receive a fractional wage from the program administration as described below. When performing their employment duties (209), apprentices are expected to attend their place of employment several times a week, the exact frequency and duration of each employment period is subject to the requirements of the business and the nature of the employment. The apprentices must perform their employment duties in a satisfactory manner (210). That is, the apprentices must perform their employment duties (209) in a manner that meets the reasonable expectations of the business providing the employment opportunity, or would be expected from a similar employee in a similar position of employment. If the apprentice does not perform satisfactorily (210), the business has the option to replace the apprentice (211) with another apprentice. The new apprentice will receive instructions and training for their selected field of employment (208) as did the previous apprentice.

If the apprentice performs satisfactorily (210) throughout the duration of their period of employment, the apprentice must take exit examinations (212) before graduating from the program (214). The exit examinations can be a written, oral, or combination thereof examination that tests the apprentice on the knowledge gained from their employment experience. In some embodiments, the exit examinations may be specialized examinations administered by a professional organization relevant to the field of employment chosen by the apprentice. These specialized examinations may include, but are not limited to, Board of Cosmetology examinations, American Welding Society examinations, ASE Certification examinations, state or local contractor license examinations, or other similar examinations.

If the apprentice passes their exit examinations, and completes their standard educational program (205), then they will graduate from the apprentice program (214). If the apprentice does not pass their exit examinations (213) then they must receive additional instructions and training for their selected field of employment (208) and repeat at least some of the program steps beginning at (208). Exactly what an apprentice that fails their exit examinations must repeat is determined by the program administration on an individual basis.

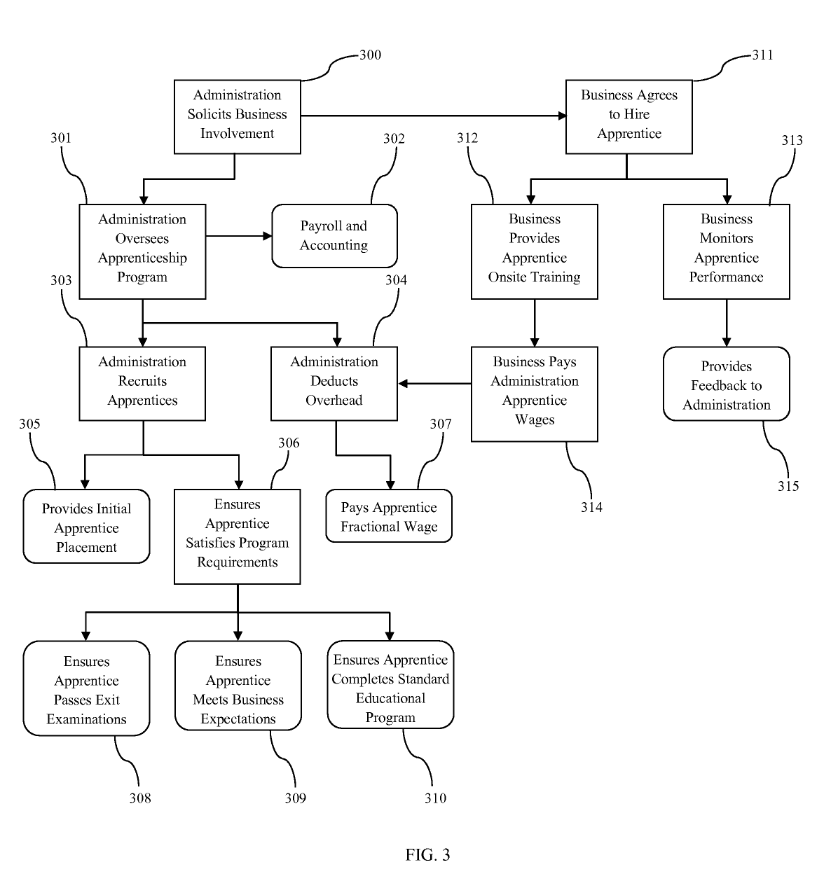

After graduating from the program (214), apprentices will receive their salary directly from the business that is employing the apprentice (215) should the business decide to continue employment. The salary the apprentice receives directly from the business (215) will be the increased amount that the business was previously paying to the program administration (FIG. 3 (314)) as described below. The increased amount is the full amount of the wages that the business was paying and not the fractional wage rate that was paid to the apprentice (FIG. 3 (307)) during the apprentice's involvement in the program.

If the business decides not to continue employment, the apprentice will still have received important on-the-job training, have completed their standard educational program, and will be qualified to seek similar employment elsewhere.

Referring now to FIG. 3, there is shown a flowchart of the responsibilities and relationships between a student apprentice program administration and a business that hires a program apprentice as according to one embodiment of the present invention. The administration is responsible for bringing local business in to the program by soliciting business' involvement (300). Businesses are encouraged to become involved because the program offers many benefits to a local community such as providing qualified workers for local businesses, helping students obtain on-the-job training, and enhancing the economy and workforce of a local community.

The administration is responsible for program oversight (301). The administration must make sure that the program meets any federal, state, or local requirements, and continues to operate within a local community. The administration operates as its own business in that it operates in a manner similar to a temp service. The administration is responsible for payroll and accounting (302) and for performing any other business services necessary as part of administrating the student apprentice program.

As part of the overseeing the apprentice program (301), the administration is responsible for recruiting apprentices into the program (303). Since the program is an optional educational path for high school students, administrations in some embodiments of the present invention, may choose to advertise within local high schools or within the local community. The administration has wide discretion on the best manner with which to recruit students into the apprentice program (303).

Also as part of overseeing the apprentice program (301), the administration is responsible for handling the finances of the program. The administration charges and receives apprentice wages from a business. In order to achieve and maintain financial self-sufficiency, the administration deducts overhead and operating expenses (304) from the received wages. The administration then pays the apprentice a fractional wage (307) which is the difference between the wage amount received from a business minus the overhead and other costs deducted by the administration. This fractional wage is not less than applicable state, federal, or local minimum wages.

After recruiting apprentices into the program (303), the administration presents apprentices with the available employment opportunities (FIG. 2 (206)) and liaises with the business that the apprentice selects to establish the initial placement of the apprentice (305). The administration provides initial placement of the apprentice (305) by ensuring that the apprentice is a satisfactory match for the requirements of the position and notifying the business that an apprentice is interested in beginning employment. The administration then communicates the necessary information to the apprentice so that the apprentice can begin the instructional and training phase of their employment (FIG. 2 (208)).This necessary information can include, but is not limited to, informing the apprentice where the business is located, what dates and times they must show up at the business, and what type of duties they will be expected to perform.

During the course of the apprentice's involvement with the program, the administration is responsible for ensuring that the apprentice satisfies the program's requirements (306). Ensuring that the apprentice satisfies program requirements includes ensuring each apprentice passes their exit examinations (308) before being allowed to graduate from the program (FIG. 2 (214)). Administrations can ensure that apprentices pass their exit examinations (308) by implementing a monitoring program that offers assistance to apprentices throughout their apprenticeship to help the apprentice prepare for their exit examinations. The monitoring program may also comprise pre-exit examinations that test the apprentices' knowledge or skills as they progress through the program. The administration may also implement a tutoring program that offers tutoring assistance to apprentices requiring additional instruction or teaching.

Ensuring that the apprentice satisfies the program requirements (306) also includes ensuring each apprentice meets the expectations of the business that is employing the apprentice (309). Businesses involved with the program (FIG. 1 (104)) expect apprentices to perform their occupational duties in a timely, efficient, and competent manner. Some of the expectations that a business will have for each apprentice include, but are not limited to, showing up to work at scheduled times, performing work duties in a competent and capable manner, satisfying the needs of customers, being able to work with co-employees, furthering the interests of the business whenever practicable, and satisfying any job-specific duties required of the apprentice.

The program administration is also responsible for ensuring each apprentice completes their standard educational program (310). The program administration can liaise with teachers or school (FIG. 1 (103)) personnel to monitor the status of apprentices in the standard educational program. Program administration can be informed if the student is falling behind in their coursework or grades and can provide additional assistance to troubled apprentices such as assigning mentors to the apprentice or offering counseling. Program administration will be informed when each apprentice successfully completes their standard educational program (FIG. 2 (205)) so that the apprentice will be allowed to graduate from the program (FIG. 2 (214)).

Businesses that decide to become involved with the program agree to hire apprentices that are interested in working for, or learning from, the business (311). Businesses that become involved with the program will be local businesses in the community that implements the program. The goal of the program is to provide a trained, competent workforce in order to economically benefit each community that chooses to use the present invention.

After a business agrees to hire an apprentice (311) that business provides onsite training to each apprentice that decides to work for the business (312). Onsite training is necessary for both parties. Onsite training provides the apprentice with critical occupational skills that will allow them to enter the job market and seek employment in their desired field upon graduation from the program (FIG. 2 (214)), and allows the business to inform the apprentice of their job obligations and duties. Onsite training (312) is also necessary so that the apprentice can learn the business' expectations and satisfactorily perform their duties (FIG. 2 (210)). If the apprentice satisfactorily performs their duties, then the business pays the program administration the apprentice's wages (314). The wage paid by the business to the administration is a higher wage than the fractional wage paid by the administration to the apprentice (307). The administration deducts overhead and operating cost from the higher wage (304) so that the program can establish and maintain financial self-sufficiency.

Each business is responsible for monitoring their apprentice's performance (313). The business can take appropriate actions to remedy sub-standard apprentice performance such as providing additional onsite training (312). The business also provides feedback to the administration (315) regarding the performance of the apprentice. The administration is kept informed of whether the apprentice is satisfactorily performing their duties (FIG. 2 (210)). Feedback can also consist of any suggestions or recommendations that a business may have for improving the efficacy of the program, a business's future expectations regarding whether they plan to continue involvement in the program, or whether the apprentice program is producing noticeable benefits to the business.

The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus and articles of manufacture have been described herein, the scope of coverage of this patent application is not limited thereto. On the contrary, this patent application covers all methods, apparatus and articles of manufacture fairly falling within the scope of the invention either literally or under the doctrine of equivalents.

To the extent the above specification describes example components and functions with reference to particular compliance requirements, standards and/or protocols, it is understood that the teachings of this disclosure are not limited to such compliance requirements, standards and/or protocols. Such compliance requirements, standards and/or protocols are periodically superseded or revised by newer versions. Accordingly, replacement compliance requirements, standards and/or protocols having the same general functions are equivalents which are intended to be included within the scope of this description.

Therefore, the foregoing is considered as illustrative only of the principles of a dual education student apprentice program. Further, since numerous modifications and changes will readily occur to those skilled in the art, it is not desired to limit the student apprentice program to the exact construction and operation described, and accordingly, all suitable modifications and equivalents may be resorted to, falling within the scope present invention. While the above description describes various embodiments of the present invention, it will be clear that the present invention may be otherwise easily adapted to fit any configuration where implementing a dual education student apprentice program is desired or required.

As various changes could be made in the above constructions without departing from the scope of the invention, it is intended that all matter contained in the above description shall be interpreted as illustrative and not in a limiting sense.

I claim:

1. A method for providing a dual education student apprentice program comprising:
presenting an apprentice with employment options upon entry into the dual education student apprentice program; requiring that the apprentice complete a standard educational program in order to graduate from the dual education student apprentice program; monitoring the standard educational program status of the apprentice as the apprentice completes the standard educational program; charging wages from a business that is participating in the program for the apprentice's employment; receiving from the business the apprentice's wages; deducting an operating amount from the received wages; paying the apprentice a fractional wage; ensuring that the apprentice performs their occupational duties in a satisfactory manner; ensuring that the apprentice satisfies all student apprentice program requirements; and allowing the apprentice to graduate from the dual education student apprentice program if the apprentice completes the standard educational program, passes exit examinations, and has satisfactorily performed their occupational duties.

2. The method of claim 1, wherein the employment options are offered by the business participating in the dual education student apprentice program.

3. The method of claim 2, wherein the business participating in the program is a local business in the community that is implementing the dual education student apprentice program.

4. The method of claim 1, wherein apprentices participating in a school athletics program as part of their standard educational program must attend five school periods per school day.

5. The method of claim 1, wherein apprentices not participating in a school athletics program as part of their standard educational program must attend four school periods per school day.

6. The method of claim 1, comprising the additional step of recruiting high school students to become involved in the dual education student apprentice program.

7. The method of claim 1, comprising the additional step of recruiting businesses to become involved in the dual education student apprentice program.

8. A method for operating a dual education student apprentice program in a community comprising:
soliciting local businesses in the community to become involved in the dual education student apprentice program and to offer employment for apprentices in the dual education student apprentice program; recruiting local high school students to become involved in the dual education student apprentice program; performing business services for the dual education student apprentice program; charging the local businesses a wage amount for the services rendered by an apprentice hired by the local business; receiving the wage amount from the local businesses; deducting from the received wage amount an amount as compensation for performing the business services for the dual education student apprentice program; paying the apprentice a fractional wage; ensuring that the apprentice completes a standard educational program; ensuring the apprentice satisfactorily completes their occupational duties; administering an exit examination; ensuring the apprentice passes the exit examination; and allowing the apprentice to graduate from the dual education student apprentice program if the apprentice has completed the standard educational program, has satisfactorily performed their occupational duties, and has passed the exit examination.

9. The method of claim 8, wherein a business is considered local if it is within the same community that is implementing the dual education student apprentice program.

10. The method of claim 8, comprising the additional step of presenting apprentices with employment options after the apprentice enters the dual education student apprentice program.

11. The method of claim 8, wherein ensuring that the apprentice completes a standard educational program further comprises requiring the apprentice to attend five class periods a day if the apprentice is participating in a school athletics program or four class periods a day if the apprentice is not participating in a school athletics program.

12. The method of claim 8, wherein ensuring the apprentice satisfactorily completes their occupational duties further comprises replacing an apprentice with another apprentice if the first apprentice is not satisfactorily completing their occupational duties.

13. The student apprentice program of claim 8, wherein the standard educational program is a high school curriculum.

14. A dual education student apprentice program administration method comprising:
performing businesses services for a dual education student apprentice program; recruiting high school students in to the dual education student apprentice program, the high school students being considered apprentices upon acceptance into the program; soliciting businesses in the community in which the dual education student apprentice program is implemented to offer the apprentices employment opportunities; requiring that businesses offering apprentices employment opportunities provide onsite training; charging the businesses a higher wage amount for the services rendered by the apprentices to the businesses; deducting a compensation amount from the higher wage amount as compensation for the businesses services provided to the dual education student apprentice program; paying the apprentices a fractional wage amount which is the higher wage amount minus the compensation amount; ensuring the apprentices complete a standard educational program; ensuring the apprentices satisfactorily perform their occupational duties; replacing a first apprentice with a second apprentice if the first apprentice does not satisfactorily perform their occupational duties; ensuring the apprentices satisfy the requirements of the dual education student apprentice program; and ensuring the apprentices pass an exit examination.

15. The dual education student apprentice program administration method of claim 14, wherein the dual education student apprentice program receives initial funding from a government agency.

16. The dual education student apprentice program administration method of claim 14, wherein the high school students are recruited from the community in which the dual education student apprentice program is implemented.

17. The dual education student apprentice program administration method of claim 16, wherein the high school students attend a high school in the community that implements the dual education student apprentice program.

18. The dual education student apprentice program administration method of claim 14, wherein the components of the method are made using a color that does not distract a shooter when the shooter uses the student apprentice program.

19. The dual education student apprentice program administration method of claim 14, wherein the method is performed by a dual education student apprentice program administrative body.

20. The dual education student apprentice program administration method of claim 19, wherein the administrative body comprises personnel responsible for the operation of the dual education student apprentice program.
